(19) United States
(12) Patent Application Publication
(10) Pub. No.: US 2004/0022610 A1
(43) Pub. Date: Feb. 5, 2004

(54) Method and apparatus for transporting a group of containers

(76) Inventor: Frank R. Nunes JR., Carmel Highlands, CA (US)

Correspondence Address: Garrettson Ellis, Seyfarth Shaw, Suite 4200, 55 East Monroe Street, Chicago, IL, 60603, US

(21) Appl. No.: 10/345,575

(22) Filed: Jan. 15, 2003

Related U.S. Application Data
(63) Continuation-in-part of application No. 10/210,462, filed on Jul. 31, 2002.

(51) Int. Cl. B66F 9/06

(52) U.S. Cl. 414/399

(57) ABSTRACT

A method of transporting a group of containers resting on a pallet without transporting the pallet, which comprises: inserting the prongs of a first forklift vehicle in the first open grooves defined in a first support surface of a pallet underneath the group of containers, with the prongs being positioned to support all of the containers. The group of containers is lifted from the pallet, and transported to a transport vehicle having second open grooves defined in a second support surface. The prongs of the forklift are inserted into the second open grooves so that the container rests on the second support surface, and the prongs are withdrawn. The group of containers is transported to a new destination with the transport vehicle, and the group of containers is similarly unloaded by the use of prongs of a second forklift vehicle. Optionally, the group of containers is placed upon a second pallet having grooves similar to those of the first pallet.

### CROSS REFERENCE TO RELATED APPLICATION

This is a continuation-in-part of U.S. patent application Ser. No. 10/210,462, filed Jul. 31, 2002.

### BACKGROUND OF THE INVENTION

Containers of merchandise such as produce containers are typically transported in a group, strapped or otherwise secured to a pallet, which is typically made of wood. Produce containers are often stacked together on a pallet in an arrangement called the “5-down pattern.” In this pattern, three rectangular containers are stacked in a row on the pallet, and in the remaining pallet space two rectangular containers are stacked with the longest dimension being perpendicular to the longest dimension of the three rectangular containers, resulting in a generally square array of containers on the pallet. Then, several other layers of containers are stacked on this bottom layer of containers, and containers are secured to the pallet with strapping, plastic sheeting, and the like.

As one cost and disadvantage of the shipment of products such as produce or manufactured items from a source of supply to the consumer, the respective pallets tend to make a one way trip, where they accumulate at receiving sites, often forming a small mountain of pallets. This is, of course, obviously wasteful both of wood, trees, and money. The pallets are costly, but not costly enough that it is of economic advantage to ship them back empty to the source of goods for reuse.

By this invention, a system is developed with which groups of containers may be handled in a conventional manner of pallet transportation, while the pallets which carry the groups of containers are not transported for the entire journey along with the containers. This reduces the number of pallets required and the one way flow of pallets from a production area to the customer, so that the customer is not burdened with great quantities of surplus pallets.

### DESCRIPTION OF THE INVENTION

By this invention, a method is provided of transporting a group of containers initially resting on a pallet without transporting the pallet. The method comprises the following steps:

The prongs of a first forklift vehicle are inserted into first, open grooves defined in a first support surface of a pallet underneath the group of containers carried on the pallet. The prongs are positioned to support all of the containers in the group. The containers are then lifted from the pallet, with the group of containers being transported by means of the forklift to a transport vehicle.

The prongs of the forklift are inserted into second, open grooves defined in a second support surface of the transport vehicle, to permit the group of containers to rest on the second support surface. One then withdraws the prongs from the second, open grooves.

The group of containers is then transported to a new destination by means of the transport vehicle.

Following this, the group of containers is unloaded from the transport vehicle by inserting prongs of a second forklift vehicle into the second open grooves, and lifting and removing the group of containers from the second vehicle.

Optionally, the prongs of the second forklift, carrying the group of containers, may be inserted into third open grooves of another pallet, to permit the group of containers to rest on a third support surface of that pallet, followed by withdrawing the prongs of the second forklift, to provide efficient transportation of the group of containers from one location to another without transporting the pallets, so that a surplus of pallets does not have to accumulate at the new destination, and avoiding the need of purchasing or manufacturing a constant supply of pallets at the original location where the containers are assembled into their groups.

Preferably, the containers rest on the pallet in the “5-down pattern”, although other patterns may be used. The prongs of the forklift vehicle are arranged in a manner capable to lift all of the containers in the group. In some embodiments, the first forklift vehicle may insert four or six prongs respectively into four or six spaced, first open grooves of the pallet in an arrangement that supports all of the containers in the group.

The transport vehicles used may be of any desired type, particularly truck trailers, portable containers such as large containers for railroad cars, the railroad cars themselves, aircraft, boats, or other vehicles. The second support surface of the transport vehicle used may comprise a second, open-groove-defining structure resting on the floor of a cargo compartment of the transport vehicle. Such a structure may be made out of wood, and is reusable at any time by placement onto the floor of the cargo vehicle when its use is desired. Alternatively, the floor itself of the transport vehicle may carry desired second open grooves. These second open grooves generally do not interfere with the transport of other loads that do not require use of the second open grooves in the manner described herein.

Thus, a significant expense can be saved by means of the great reduction in the number of pallets necessary to transport large quantities of containers from an original location to a desired destination.

To facilitate this invention, a special pallet may be provided for supporting a group of containers of general conventional assemblage except as otherwise described herein. The pallet defines a horizontal support surface and sidewalls. The support surface defines spaced, parallel, open grooves for receiving prongs of a forklift vehicle, to lift the group of containers from the pallet. The sidewalls define a spaced, parallel plurality of recesses that are open at the bottom of the pallet, for receiving prongs of a forklift vehicle to lift the plurality of containers and the pallet together. The grooves and the recesses may be of the same pattern of arrangement or different, as may be desired. For example, the open bottom recesses may be of conventional arrangement for a pallet, so that a conventional fork of a forklift vehicle may lift the pallet, while the spacing of the open grooves may be different from the spacing of the bottom recesses, to permit lifting of the group of containers in five-down arrangement as one, for example in the manner and pattern illustrated herein. Thus, by this invention, the pallet and the group of containers may be simultaneously lifted, and also the group of containers may be lifted away from the pallet.

As previously described, the open grooves may be positioned to support at least one layer of a group of containers comprising five containers arranged in the “5-down pattern.” Not only can the pallet carry one such layer, but it may carry a substantial number of such layers in a stack, up to about twelve layers, without limitation, and still may be transported in accordance with this invention.

In one group of embodiments, the pallet may have four of said open grooves present on its horizontal support surface, with the open grooves comprising two end grooves and two central grooves. The pallet may carry a plurality of containers, with the two central grooves each extending directly underneath abutting faces of adjacent containers, to permit a prong of the forklift vehicle which occupies each central groove to support both of the adjacent containers which have the abutting faces.

For simplicity of construction, the end grooves described above may each be open at one side so that they resemble a step in cross section. A forklift vehicle having a forklift assembly which comprises four spaced, parallel prongs is then capable of entering them into the open grooves of this particular embodiment of the pallets of this invention.

Alternatively, six open grooves (and prongs) may be provided, with at least two grooves and prongs extending underneath each container, arranged for example in the 5-down pattern.

This invention may be used with forklift vehicles which have flat prongs, as shown in a first embodiment, or with prongs of other cross sectional shapes, for example prongs having an inverted U-cross section for strength increase, with the open grooves typically being of a corresponding shape, as shown in a later embodiment below.

Thus, by this invention, significant financial savings may be achieved by the reduction of the number of pallets which are necessary to transport groups of containers, resulting in higher profit margins and lower shipping costs.

### DESCRIPTION OF DRAWINGS

In the drawings, FIG. 1 is a perspective view showing a single layer of a group of containers in the “5-down pattern,” shown being carried on a pallet made in accordance with this invention.

FIG. 2 is a perspective view of a truck trailer, with portions broken away, showing the grooved flooring of the trailer which facilitates loading multilayer groups of containers by means of a forklift vehicle without pallets.

FIG. 3 is a fragmentary, elevational view, with a portion broken away, showing how the respective forks of forklift vehicles can lift either the group of containers from the pallet, or can lift the pallet itself along with the group of containers.

FIG. 4 is a fragmentary elevational view, taken from the other side of the group of containers with respect to FIG. 3, showing how the group of containers may be deposited on and raised from the floor of the vehicles, permitting the group of containers to be transported without the pallet upon which they originally rested.

FIG. 5 is a flow chart illustrating a specific transport method.

FIG. 6 is a perspective view of another embodiment of the pallet of this invention.

FIG. 7 is a top plan view of the pallet of this invention, with a layer of containers carried thereon in the 5-down pattern.

FIG. 8 is an elevational view of the pallet of FIG. 7 and layer of containers carried thereon, showing how prongs from a forklift truck can lift the layer of containers upwardly from the support surface of the pallet.

FIG. 9 is a fragmentary, perspective view of a truck bed as modified in accordance with this invention, further showing a fragmentary perspective portion of the forks of a forklift vehicle which load containers onto the truck bed.

FIG. 10 is an enlarged perspective view of a modified portion of the truck bed of FIG. 9.

FIG. 11 is a fragmentary, sectional view taken along line 11-11 of FIG. 9.

FIG. 12 is a fragmentary, sectional view taken along line 12-12 of FIG. 10.

### DESCRIPTION OF SPECIFIC EMBODIMENTS

Referring to the drawings, FIGS. 1-3 show a pallet 10, in accordance with this invention, which carries five equally sized, rectangular containers 12 for produce such as lettuce, fruit, or other vegetables, carried on pallet 10 in a “5-down pattern.” It can be seen that the five rectangular containers 12 are in this embodiment placed upon the generally square pallet in a first row 14 of three containers 12 and a second row 16 of two containers 12, with the longest dimensions of the containers in their respective rows 14, 16 being perpendicular to each other. The container 12 may be secured in position by a peripheral strap of polyethylene sheeting 17, or a complete wrapping of the containers in plastic sheeting, or by other forms of strapping, or in any other conventional way of securing the containers 12 together. But, typically, the group of containers 12 rest upon, but are not secured on, pallet 10. Instead, they are removable.

Furthermore, it is contemplated that in many circumstances a multiplicity of layers of the containers 12 will be stacked on the layer of containers shown in FIG. 1 to form the group of containers, although a single layer of containers may also be used. These upper layers of containers may be stacked together in the “5-down pattern” or in any other appropriate pattern on the lower layer.

When it is desired to transport the group of containers 12, group of containers 12 may be lifted by forklift vehicle 18, carrying a plurality of spaced, horizontally extending prongs 20 as shown in FIG. 2. Forklift vehicle 18 may be generally conventional, but optionally with a distribution and arrangement of prongs 20 which are different from those of the prior art, and which are spaced and shaped to fit into the plurality of first open grooves 22, 24, which are defined in a first support surface 26 of pallet 10. Pallet 10 may be conventionally made of wooden boards defining the grooves 22, 24 and sidewalls 28, plus the first support surface 26. If desired, first support surface 26 may be defined by separate boards 30, which may be attached to sidewalls 28 to define the complete pallet 10, with grooves 22, 24 being defined by spaces between boards 30. Boards 30 may be elevated by intermediate pieces attached to sidewalls 28, if desired, to deepen grooves 22, 24 and to provide walls on three sides of the grooves 20, to facilitate prong placement in the grooves.

FIG. 3 shows how the respective prongs 20 of forklift vehicle 18 can slide into first open grooves 22, 24 underneath the group of containers 12. Particularly, the inner prongs 20a can be positioned to support adjacent containers in row 14 along their mating side surfaces 32, as shown by the broken portion of FIG. 3. Thus, each inner prong 20a supports a respective side of two containers 12 in row 14, while only supporting part of a single container in the row 16. Thus, the particular arrangement of prongs 20 is suitable for supporting a group of containers 12 where the bottom layer of such containers is placed in the conventional “5-down pattern,” as shown in FIG. 1.

It can also be seen from FIG. 3 that pallet 10 and the group of containers carried thereon can be conventionally lifted by a forklift having a generally conventional arrangement of a pair of forks 36, which fit in the conventional downwardly facing recesses 38 respectively defined in two sidewalls 28 of the pallet 10.

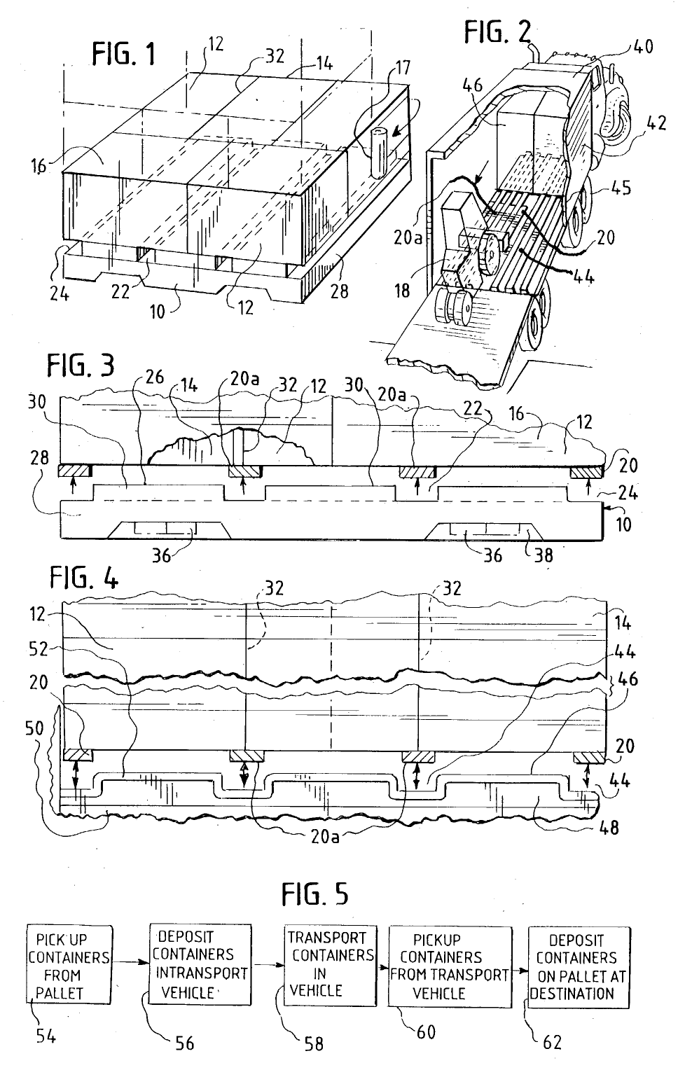

Further in accordance with this invention, a group of containers 12, carried on a pallet 10, may be transported while leaving the pallet behind by first inserting the prongs 20, 20a of forklift vehicle 18 into first open grooves 22, 24, and lifting the load as shown in FIG. 3. The load is then transported by means of the forklift to a transport vehicle 40, shown to be a truck trailer in FIG. 2. It can be seen that the cargo compartment 42 of truck trailer 40 has a floor which comprises second open grooves 44 defining a second support surface 46 (FIG. 4) of the cargo compartment, the grooves 44 being spaced to permit the respective forks 20, 20a of the forklift vehicle to be received within grooves 44 so that the respective groups of containers 12 can rest upon second support surface 46. The prongs 20, 20a can then be withdrawn. This is generally shown in FIG. 4, where grooves 44 and second support surface 46 can comprise an integral structure which overlays the bed 50 of the cargo trailer 42. Alternatively, the grooves 44 and second support surface 46 can be an integral part of the trailer bed. Also, as shown, a protective surface 52 may be provided covering the respective grooves 44 and support surface 46.

As shown in FIG. 5, the steps of the process are illustrated:

In the first step 54, the containers are picked up from pallet 10 and deposited 56 in transport vehicle 42. Further as described, the containers are then transported 58 to the desired new destination in vehicle 42.

Then, as in 60, each group of containers 46 may be unloaded by inserting prongs 20, 20a of typically a second forklift vehicle, also represented by reference number 18, into second open grooves 44, and raising and removing the group of containers 46 from the transport vehicle, also as illustrated in FIG. 4. As before, the inner prongs 20a carry edges of two adjacent containers 12 in row 14, at the junction face 32 of the respective containers. Each of the containers 12 and forward row 16 are respectively carried by a pair of prongs 20, 20a, the particular arrangement shown being the “5-down pattern.” Following this, as step 62, each group of containers 12 may be deposited on a new pallet, also represented as 10 in FIG. 1, to complete the transport of groups of containers between locations without transporting the pallets upon which they may be stored.

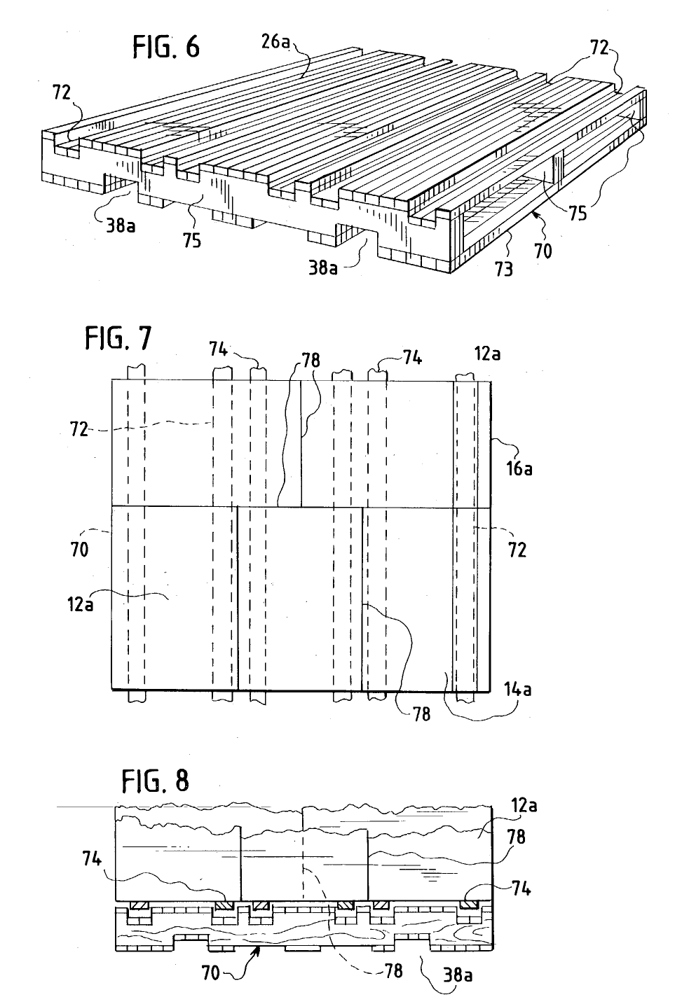

FIGS. 6-8 show another design of pallet 70, which may be handled and processed in a manner similar to that described above with respect to pallet 10. Pallet 70 can be seen to be made out of a collection of wooden boards, secured together by screws or nails, to provide an inexpensive pallet of desired shape. For example, first support surface 26a and bottom surface 73 can be made of 1×4 inch boards, or plywood vertical members 75 may also be identically shaped boards, as may other parts of pallets 10 and 70. As before, pallet 70 defines first open grooves 72, the number of such grooves being six in this embodiment. Also, as in the previous embodiment, bottom recesses 38a may be provided, for lifting by a conventionally proportioned forklift truck having two prongs. Bottom recesses 38 or 38a may also be numbered and proportioned to be engagable by the modified forklift 18, having four or more prongs, per this invention.

FIG. 7 shows a top plan view of a group of containers 12a, such as cardboard boxes, arranged in a first row 14a of three containers 12a, and a second row 16a of two containers, comprising similar containers to the previous embodiment, arranged again in the 5-down pattern and carried on first support surface 26a of pallet 70.

Six prongs 74 from a forklift truck can be seen to be extending in open grooves 72, in a manner similar to the previous embodiment. However, because six grooves 72 are present, they may be arranged in the manner shown in FIG. 7 so that each container 12a is supported by at least two prongs 74 as carried in the respective open grooves 72, so that if containers 12a are flexible, they may be more reliably supported than in the previous embodiment, although the arrangement of the previous embodiment is very suitable if the packages have sufficient rigidity. The respective, abutting faces 78 at sides of the respective containers can be seen in FIGS. 7 and 8.

FIG. 8 shows how the lift truck, using prongs 74, may lift the group of containers 12a upwardly off of pallet 70 when it is desired to transport the group of pallets in the manner previously described in a vehicle such as transport vehicle 40 to a new destination in a manner substantially identical to what has been described above, with the primary difference being the number and arrangement of first open grooves 72 and prongs 74 of the forklift vehicles which handle the group of containers when they are not resting on a pallet. Accordingly, similar advantages may be achieved with this embodiment of pallet as with the previous embodiment.

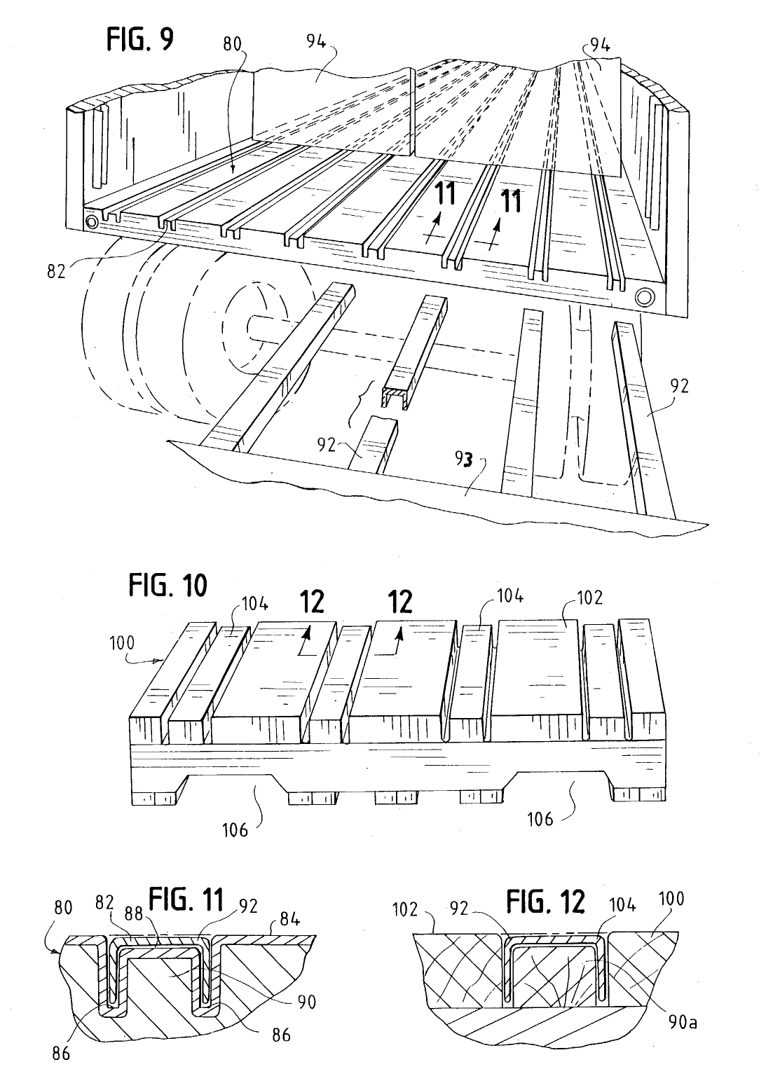

Referring to FIGS. 9 through 12, FIG. 9 shows a truck bed 80, which defines a series of spaced, parallel grooves having a cross section of the shape of an inverted U. As seen particularly in FIG. 11, truck bed 80 may be coated with a plastic material 84 for friction reduction, if desired, while the inverted U-shape of groove 82 can be seen. Groove 82 comprises a pair of downwardly extending groove portions 86 and a central, recessed horizontal portion 88 of less depth than portions 86, the depth being reduced by central rib 90, which may be part of truck bed 80. It is possible to practice this invention without the presence of the various ribs 90, so that a large groove of generally rectangular cross section exists. However, this can serve as a safety hazard, since the groove may be large enough to cause loaders and other people who are walking on the truck bed to sprain ankles and fall as they stumble in the grooves. Accordingly, it is preferred for ribs 90 to be present to suppress injuries, since this suppresses stumbling and sprain injury.

Grooves 82 may be proportioned to receive forklift prongs 92, attached to a base 93 which may together comprise a fork which is conventionally attachable or attached to a forklift truck. It can be seen that U-shaped grooves 82 are preferably proportioned so that the U-shaped prongs 92 can fit therein without significantly projecting above the plane of truck bed 84, so that they can be used to carry containers 94, typically in groups in a five-down pattern or the like. The containers may be placed into the truck bed, with the prongs being withdrawn through grooves 82 in a manner which is similar to that described with respect to the previous embodiments, to permit the transport of groups of containers without a pallet, and their removal from a pallet and their reinstallation on a pallet, as may be desired.

It can also be noted that prongs 92 in their inverted U-cross sectional shape will have increased load bearing strength with less deformation, when compared with the prongs 20, 74, or the like of comparable size.

Referring particularly to FIGS. 10 and 12, a particular pallet 100 is shown, having a support surface 102 that comprises a plurality of parallel grooves 104 which are of inverted U-cross sectional shape in a manner similar to grooves 82. Accordingly, the same prongs 92 of a forklift can be inserted to lift loads of containers from the pallet and to place loads on them, while withdrawal of the forks 92 is facilitated by the presence of grooves 104 as the pallets rest upon the support surface 102.

Pallet 100 also defines a spaced, parallel plurality of recesses 106 which are open to the underside of pallet 100, being opposed in their opening direction to the upward opening of grooves 104. These recesses, as with recesses 38, 38a in the previous embodiments, can receive conventional forks from a forklift truck so that the pallet 100, with or without a load, may be lifted and moved by a conventional forklift. Alternatively, such grooves 106 may be similar in number and shape to the upper grooves of the pallet, such as grooves 104.

If desired, pallets like pallets 100 may be placed upon a conventional flat bed of a truck, railroad car, or other vehicle to convert such a flat bed into a bed similar to that shown as bed 80 in FIG. 9, so that loads of containers 94 may be placed and removed on the bed without any added pallets. The pallets 100 then remain with the truck bed while the containers come and go for as long as may be desired. Then, if it is desired to reconvert the truck bed back to a flat bed, pallets 100 may simply be removed.

Thus, by the use of a few, semi-permanent pallets 100 which are carried with the truck bed for a substantial length of time, while various package loads are loaded on the truck bed upon pallets 100, transported, and then removed again while leaving pallets 100 behind (as if they were an integral part of truck bed 80), the advantages of this invention can be achieved in terms of the avoidance of accumulation of pallets at a delivery destination. Then, when desired, the truck can be converted back into a conventional flat bed truck simply by removal of the pallets.

Central rib 90a, as shown in FIGS. 10 and 12, may serve the same function as rib 90 in FIGS. 9 and 11, providing better footing for workers that walk on the grooved surface.

In summary, groups of containers may be easily transported without the pallet upon which they may be stored in a warehouse, resulting in a net saving in the number of pallets needed and the avoidance of the wasteful accumulation of pallets at sites where the goods associated with the pallets are received. While this invention is specifically shown for use with containers of produce, it may be used for any type of goods that are typically carried on pallets in groups of containers, for example, consumer goods such as dishwashers and television sets; raw materials; paper goods such as napkins, paper towels, and books; and other manufactured items or agricultural products.

The above has been offered for illustrative purposes only, and is not intended to limit the scope of the invention of this application, which is as defined in the claims below.

That which is claimed is:

1. The method of transporting a group of containers resting on a pallet without transporting the pallet, which comprises:
inserting the prongs of a first forklift vehicle into first grooves defined in a first support surface of a pallet underneath the group of containers, said prongs being positioned to support all of said containers; lifting from the pallet and transporting the group of containers with the forklift to a transport vehicle; inserting the prongs of the forklift into second grooves defined in a second support surface of the transport vehicle to permit the group of containers to rest on the second support surface; withdrawing the prongs from the second grooves; transporting the group of containers to a new destination with the transport vehicle; and unloading the group of containers by inserting prongs of a second forklift vehicle into said second grooves and lifting and removing the group of containers from the second vehicle.

2. The method of claim 1 which further comprises the step of thereafter inserting said prongs of the second forklift into third grooves of another pallet to permit the group of containers to rest on a third support surface of said another pallet, and withdrawing the prongs of the second forklift.

3. The method of claim 1 in which said containers rest on the pallet in a 5-down pattern.

4. The method of claim 3 in which the first forklift vehicle inserts four prongs respectively into four spaced, first grooves of the pallet.

5. The method of claim 1 in which the transport vehicle comprises a truck trailer.

6. The method of claim 1 in which the transport vehicle comprises a portable container.

7. The method of claim 1 in which at least some of said first and second grooves have an inverted U-cross sectional shape.

8. The method of claim 1 in which the second support surface of the transport vehicle comprises a second groove-defining structure on the floor of a cargo compartment of said transport vehicle.

9. The method of claim 1 in which the first forklift vehicle inserts four to six prongs respectively into four to six spaced, first grooves of the pallet.

10. A pallet for supporting a group of containers, said pallet defining a horizontal support surface and sidewalls, said support surface defining grooves for receiving spaced, parallel prongs of a forklift vehicle, to lift said group of containers from the pallet; said sidewalls defining a spaced, parallel plurality of recesses that are open at the bottom for receiving prongs of a forklift vehicle, to lift both the group of containers and the pallet.

11. The pallet of claim 10 in which said grooves are positioned to support at least one layer comprising five containers arranged in the 5-down pattern.

12. The pallet of claim 11 in which four of said grooves are present, comprising two end grooves and two central grooves, the pallet carrying a plurality of containers, in the 5-down pattern, the two central grooves each extending directly underneath abutting faces of adjacent containers to permit a said prong in each central groove to support both of said adjacent containers having said abutting faces.

13. The pallet of claim 12 in which the end grooves are open at one side.

14. The pallet of claim 10 in which four of said grooves are present, comprising two end grooves and two central grooves, the pallet carrying a plurality of containers, the two central grooves each extending directly underneath abutting faces of adjacent containers to permit a said prong in each central groove to support both of said adjacent containers having said abutting faces.

15. The pallet of claim 14 in which said central grooves have an inverted U-cross-sectional shape.

16. The pallet of claim 14 in which the end grooves each are open at one side.

17. The pallet of claim 10 in which at least some of said grooves have an inverted U-cross sectional shape.

18. A forklift vehicle having a forklift assembly which comprises a plurality of spaced, parallel prongs which are capable of entering into the open grooves of the pallet of claim 10.

19. The pallet of claim 10 in which four to six of said grooves are present.

20. A pallet for supporting a group of containers, said pallet defining a horizontal support surface and sidewalls, said support surface having grooves for receiving spaced, parallel prongs of a forklift vehicle, to lift said group of containers from the pallet, said pallet carrying a plurality of containers, two of said grooves comprising central grooves, each extending directly underneath abutting faces of adjacent containers to permit a prong of a forklift truck to extend into each central groove, with each prong supporting both of said adjacent containers having said abutting faces.

21. The pallet of claim 20 in which four of said grooves are present, comprising two end grooves and two central grooves, positioned to support at least one layer comprising five containers arranged in the 5-down pattern.

22. The pallet of claim 21 in which said grooves are penetrated by four spaced, parallel prongs of a forklift vehicle.

23. The pallet of claim 21 in which the end grooves are open at one side.

24. The pallet of claim 21 in which at least some of said grooves have an inverted U-cross-sectional shape.

25. A plurality of lifting prongs comprising a fork of a forklift vehicle, said prongs being attached to a base which is capable of being raised and lowered by the vehicle, at least some of the prongs having an inverted U-cross-sectional shape.

26. The lifting prongs of claim 25 in which all of said prongs have the inverted U-cross-sectional shape.

27. The lifting prongs of claim 25, said prongs occupying spaced grooves defined in a horizontal support surface of a pallet for supporting a group of containers.
